(19) United States
(12) Patent Application Publication
(10) Pub. No.: US 2025/0157048 A1
(43) Pub. Date: May 15, 2025

(54) Camera-Based System And Method For Determining And Verifying The Position Of A Trailer

(71) Applicant: MEKRA Lang GmbH & Co. KG, Ergersheim (DE)

(72) Inventors: Thomas RICHTER, Eckental (DE); Kai FAUTH, Margetshoechheim (DE); André KOEHLER, Nuernberg (DE); Christian KERSTEN, Fuerth (DE); Christian BAUER, Gutenstetten (DE); Anne SCHADE, Wuerzburg (DE)

(73) Assignee: MEKRA Lang GmbH & Co. KG, Ergersheim (DE)

(21) Appl. No.: 18/931,503

(22) Filed: Oct. 30, 2024

(30) Foreign Application Priority Data
Nov. 10, 2023 (DE) 102023131359.2

(51) Int. Cl. G06T 7/20; G06T 7/70; G06V 10/44; G06V 10/56; G06V 10/60; G06V 10/762

(52) U.S. Cl. CPC G06T 7/20; G06T 7/70; G06V 10/44; G06V 10/56; G06V 10/60; G06V 10/762

(57) ABSTRACT

A camera-based system of a vehicle having a towing unit (4) and an rearwardly extending pivotable trailer (5) has at least one image capturing device (2) located at the towing unit (4) and having an image sensor for capturing camera images (6) of the trailer (5) which are successive in time; at least one display (1) for displaying a camera image (6) captured by the at least one image capturing device (2); and at least one processor (3) configured for performing a method for verifying information about a trailer end position received from an external method, and for determining and verifying a trailer end.

### BACKGROUND OF THE INVENTION

### 1. Field of the Invention

The invention relates to a camera-based system (viewing system or mirror replacement system) and a method for determining and verifying the position of an end (edge) of a trailer rearwardly extending from a vehicle and which is pivotable to the vehicle, suitable for commercial vehicles having a semi-trailer, a trailer, or another unit pivotable with respect to a driver's cab or the tractor unit and rearwardly extending.

### DISCUSSION OF BACKGROUND

The driver of a vehicle comprising a tractor unit or towing unit having a trailer that extends to the rear, and which is pivotable to the unit, usually observes traffic behind by means of a side mirror attached to the side of the towing unit. Such side mirrors are increasingly being replaced by camera systems, such as camera monitor systems, respectively mirror replacement systems mounted at a side or at a rear part of the vehicle. They replace or supplement conventional mirror systems which are prescribed for a motor vehicle, such as exterior mirrors (main mirrors), interior mirrors on cars or wide-angle mirrors and front mirrors on commercial vehicles.

In the systems mentioned above, for example, a corresponding field of view, which is conventionally visible by a mirror, is permanently and in real time shown to the driver of the vehicle on a monitor or other display unit, for example in the interior of the vehicle, so that the driver of the vehicle always has a view of the corresponding field of view, although he neither has a direct view of the corresponding field of view nor is a mirror provided.

A trailer in the sense of the present teaching comprises trailers which are coupled to a vehicle (tractor or towing unit) by means of a trailer coupling, for example a semi-trailer (so-called trailers), and which are placed at the rear, lowered area of a tractor unit and pivotably connected about at least one vertical axis. Alternatively, such trailers can also be trailers attached to passenger cars, wherein in this case, the passenger car corresponds to the tractor unit. In general, a trailer is a rearwardly extending part which is located rearwardly with respect to a driver's cab of a vehicle, and a part which is movable (pivotable) to a side with respect to the driver's cab, and which pivots about a vertical axis relative to the driver's cab when cornering. Articulated trucks or articulated trains are also trailers within the meaning of the invention.

However, when using a mirror replacement system as described above, the rearward traffic is increasingly concealed in an image of a mirror replacement system for the field of view class II according to ECE R46 with increasing buckling angle (kink angle or bending angle) between a towing unit and a trailer when a vehicle with the towing unit and the trailer is cornering. Further, the rear part of the trailer is lost (disappears) near the rear axle, which can cause the end of the trailer to disappear from a monitor image displayed to the driver.

To solve this problem, there are already methods for tracking the trailer end and for shifting the image section displayed on a monitor such that the trailer end edge is displayed in the center of the monitor image, as far as this is possible. According to EP 16 198 485, this tracking of the trailer end edge is currently carried out, for example, by means of vehicle sensors, which acquire information about a rotary movement of the wheels. This information is analyzed by a control unit to determine the rear area of the rearwardly extending part and to appropriately track it based on the acquired information about the rotary movement of the wheels. However, as these sensors can only provide reliable signals above a certain speed, e.g. from approximately 2 km/h, this tracking of the trailer end edge can only be provided when driving forward at higher speeds. These sensors cannot be used for maneuvering backward and at low speeds for detecting a trailer end edge with sufficient accuracy for tracking (updating) the trailer end edge in a monitor image. Furthermore, known methods for tracking the end of a trailer have in accuracies that may need to be corrected.

### SUMMARY OF THE INVENTION

A first object of the invention is to verify a method for tracking a trailer end, i.e. to carry out a plausibility check, for example, whether a trailer end obtained or determined for tracking is acceptable.

A second object of the invention is to solve the above-mentioned problem and to detect the position of the trailer end with sufficient accuracy during backward maneuvering operations and at low speeds for tracking (updating) in a monitor image, irrespective of trailer type and information acquired by installed sensors, for example.

The above object is solved by the methods with the features according to the disclosure herein. Advantageous further developments of the invention are given in the dependent claims.

The method according to the invention for verifying a method for tracking a trailer end receives information about the position of a trailer end of a trailer extending rearwardly from a towing unit of a vehicle and being pivotable with respect to the towing unit, from a method for tracking a trailer end, which method has to be verified. The method according to the invention acquires (captures) a camera image of a side area of the trailer by an image sensor of at least one image capturing device attached to a vehicle, preferably attached to the towing unit, and so-called feature points are determined in the captured camera image based on one or more image parameters, wherein a feature point corresponds to at least one pixel or pixel cluster within the camera image. A pixel in the camera image can be determined as a feature point, if, for example, a value of an image parameter of this pixel differs from a value of a corresponding image parameter of one or more neighbor pixels by a preset value.

For example, several neighboring pixels that form a pixel cluster may also be compared with an adjacent or neighboring pixel cluster regarding at least one image parameter for determining a feature point. The pixels or pixel clusters do not have to be directly next to each other, a spatial proximity to each other may be sufficient.

Feature points can be determined, for example, based on one or more image parameters, at least a calculated value of one or more image parameters, and/or their gradients, wherein a feature point corresponds to at least one pixel within the camera image. A pixel within the camera image can be determined as a feature point, if a value of the image parameter of this pixel differs from a value of a corresponding image parameter of one or more neighboring pixels by a preset value.

For example, more neighboring pixels forming a pixel cluster can be compared to an adjacent or neighboring pixel cluster regarding at least one image parameter for determining a feature point. The pixels or pixel clusters do not have to be directly next to each other, a spatial proximity to each other may be sufficient.

The method according to the invention then generates a block grid on at least a part of the captured camera image, wherein the block grid has a plurality of columns and rows defining cells. By creating the block grid on the camera image comprising the determined feature points, a distribution of the plurality of feature points is defined over the plurality of cells of the block grid.

The method according to the invention then compares the block grid having the distribution of the feature points created in this way with distributions of feature points of a plurality of corresponding stored block grids, wherein the stored block grids respectively define different distributions of feature points together with an actual trailer end position. Based on a correlation between the distribution of feature points in the created block grid and the distributions of feature points in the stored block grids, one of the stored block grids having the information of the actual trailer end is selected and used for verifying the received information about the trailer end.

According to an advantageous embodiment of the method according to the invention, the feature points in the created block grid are weighted. Such a weighting can, for example, be based on a difference in contrasts between pixels or pixel clusters and neighboring pixels or pixel clusters or pixels or pixel clusters in close proximity. One or more known image parameters can serve as a basis for the weighting.

According to a further advantageous embodiment of the method according to the invention, the received information about the trailer end can be corrected based on the above verification, for example, if a deviation exceeds a preset threshold.

According to a further advantageous embodiment of the method according to the invention, the distributions of feature points and the corresponding trailer end positions in the stored block grids may be stored in advance or created and stored in real time in fixed defined or dynamically adjustable time intervals, for example during forward driving.

According to a further advantageous embodiment of the method according to the invention, the different distributions of feature points in the stored block grids may depend on the buckling angle or a relative positional relationship between trailer and towing unit stored together with the block grid and being part of the block grid. Such a buckling angle or such relative positional relationship may be independently determined from captured camera images, for example by means of a buckling angle sensor attached to the vehicle or may be estimated from data received from a steering angle sensor. The corresponding buckling angle may be stored together with a block grid.

According to a further advantageous embodiment of the method, the image parameter is for example at least one of brightness value, color value, grey tone or gradient of these values, wherein prior to determining the feature points in a camera image, this camera image remains unprocessed or is suitably processed to make a difference in contrast, difference in brightness, etc. even more clearly visible. Other image parameters not explicitly listed here are also conceivable.

According to a further advantageous embodiment of the method according to the invention, the method for tracking a trailer end position which has to be verified may be a radar-based method, an ultrasonic method, a lidar-based method, a CAN-based method and/or an optical method.

The method according to the invention for determining a trailer end of a trailer extending rearwardly from a towing unit of a vehicle and being pivotable with respect to the towing unit acquires a camera image of the trailer and determines a plurality of feature points in the camera image based on at least one image parameter, wherein a feature point at least corresponds to a pixel within the camera image. The method according to the invention further creates a block grid on at least a part of the captured camera image, similar to the above-described verification method according to the invention, wherein the block grid defines a plurality of cells, and determines a distribution of the plurality of feature points over the plurality of cells of the block grid. By comparing the distribution of the feature points in the created block grid with distributions of feature points of a plurality of corresponding stored block grids, wherein the stored block grids each define different distributions of feature points together with the actual trailer end, a block grid may be selected from the stored block grids that correlates best with the created block grid. The information about the trailer end stored together with the selected block grid, or associated with the selected block grid, is determined as the trailer end according to the invention.

According to a further advantageous embodiment of the method according to the invention, the distribution of feature points and the corresponding trailer end may be stored in the block grid in advance or may be created and stored in real time at fixed defined or dynamically adjustable time intervals. For example, this can be performed during forward driving. The stored block grids can then be used during a subsequent slow reverse movement (driving) to determine the end of the trailer.

According to a further advantageous embodiment of the method according to the invention, the different distributions of feature points with the corresponding trailer end in the stored block grids depend on the buckling angle between trailer and towing unit or the relative positional relationship between trailer and towing unit. The information about the buckling angle and/or the relative positional relationship can for example be stored together with each block grid. This means that, for example, if the current buckling angle is known, which is acquired by sensors mounted on the vehicle, the corresponding stored block grid for this buckling angle can directly be found and the trailer end defined in this stored block grids can be determined as the position of the trailer end.

According to a further advantageous embodiment of the method according to the invention, the determination of the trailer end can be applied for camera images successive in time, and tracking the trailer end can be realized such that the position of the trailer end is shown to the driver at a preferred position within the monitor image when cornering, for example in the center of the monitor image or shifted plus minus 10% to 25% from the center to left or right.

According to a further advantageous embodiment of the method according to the invention, the trailer end determined in this way can be verified by the above-mentioned verification method.

The systems according to the invention for verifying and determining a trailer end are camera-based systems for a vehicle having a towing unit and a rearwardly extending pivotable trailer, the systems comprising at least one image capturing means having an image sensor for acquiring camera images of the trailer which images are successive in time, and at least one processing means configured for performing the above-described method according to the invention for verifying and determining the trailer end.

Optionally, the system according to the invention comprises display means on which the position of the trailer end is displayed on a monitor image.

According to an advantageous embodiment, the camera-based system according to the invention is a mirror replacement system approved according to UN ECE R46, preferably for commercial vehicles.

According to one aspect, a method is described for tracking an end of a trailer comprising the steps of:
receiving at least an information about the position of a trailer end (12) of a trailer (5) extending rearward from a towing unit (4) of a vehicle and being pivotable to the towing unit (4), from the method for tracking a trailer end;
capturing a camera image (6) of at least a side area of the trailer by an image sensor of at least one image capturing means (2);
determining a plurality of feature points (8) in the camera image (6) based on at least one image parameter, wherein a feature point (8) corresponds to at least one pixel in the camera image (6);
generating a block grid (10) on at least a part of the captured camera image (6), wherein the block grid (10) defines a plurality of cells (11), and determining a distribution of the plurality of feature points (8) over the plurality of cells (11) of the block grid (10) as part of the generated block grid (10);
comparing the distribution of the feature points (8) in the generated block grid (10) with distributions of feature points of a plurality of corresponding stored block grids, wherein the stored block grids each define different distributions of feature points together with an actual trailer end;
selecting one of the stored block grids based on a correlation between the distribution of feature points (8) in the generated block grid (10) and the distributions of feature points in the stored block grids;
verifying the received information about the position of the trailer end (12) by comparing the actual position of the trailer end defined by the selected block grid with the received information about the position of the trailer end (12).

According to another aspect, the disclosed method further comprises a correcting of the received information about the position of the trailer end (12) based on the verification.

According to another aspect, the distributions of the feature points and the corresponding trailer ends in the stored block grids are stored in advance or generated and stored in real time at fixed defined or dynamically adjustable time intervals.

According to another aspect, the distribution of feature points in one of the stored block grids differs from the distribution of feature points in another of the stored block grids according to the relative positional relationship between trailer (4) and towing unit (5).

According to another aspect, the at least one image parameter is at least a brightness value, color value, grey tone, contrast value and/or a calculated quantity from one these values and/or their gradients of a pixel and/or pixel clusters in a camera image (6).

According to another aspect, the method for tracking (updating) a position of a trailer end is a radar-based method, an ultrasonic method, a Lidar-based method, a CAN-based method and/or an optical method.

According to another aspect, a feature point (8) corresponds to a pixel or a cluster of few directly adjacent pixels or pixels in close proximity to each other.

According to another aspect, the corresponding actual trailer ends defined in the stored block grids are obtained from another method.

According to another aspect, the disclosed method comprises:
tracking (updating) the position of the trailer end such that the trailer end appears at a preferred position in the monitor image of at least one display means (1) of a camera-based system.

According to another aspect, a camera-based system of a vehicle is disclosed, where the vehicle has a towing unit (4) and a trailer (5) rearwardly extending from and being pivotable to the towing unit (4), the system comprising:
at least one image capturing means (2) provided at the towing unit (4) and having at least one image sensor for capturing camera images (6) of the trailer (5) which are successive in time; and
at least one processing means (3) configured for performing the disclosed method(s).

According to another aspect, the camera-based system further comprises
at least one display means (1) for displaying a camera image (6) captured by the at least one image capturing means (2) and tracking the position of the trailer end in the camera images (6) which are successive in time, depending on the position of the trailer (5) with respect to an image sensor acquiring the camera images (6) such that the trailer end appears at a preferred position within the monitor image of the display means (1).

According to another disclosed aspect, the camera-based system is approved according to UN ECE R46.

In accordance with another aspect, a method is disclosed for determining a trailer end of a trailer (5) extending rearward from a towing unit (4) of a vehicle and being pivotable to the towing unit (4), comprising the steps of:
capturing a camera image (6) of the trailer (5) by an image sensor of at least one image capturing means (2);
determining a plurality of feature points (8) in the camera image (6) based on at least one image parameter, wherein a feature point (8) corresponds to at least one pixel in the camera image (6);
creating a block grid (10) on at least a part of the captured camera image (6), wherein a block grid (10) defines a plurality of cells (11), and determining a distribution of the plurality of the feature points (8) over the plurality of cells (11) of the block grid (10) as part of the created block grid (10);
comparing the distribution of the feature points (8) in the created block grid (10) with distributions of feature points of a plurality of corresponding stored block grids, wherein the stored block grids each define different distributions of feature points together with actual positions of trailer ends;
selecting one of the stored block grids based on a correlation between the feature points (8) in the created block grid 810) and the feature points in the stored block grids;
determining the position of the trailer end which is defined in the selected block grid as the end of the trailer (5).

According to a further aspect, the distribution of the feature points and the corresponding trailer ends in the stored block grids are stored in advance or created and stored in real time at fixed defined or dynamically adjustable time intervals.

According to a further aspect, the at least one image parameter is at least one of a brightness value, color value, grey tone, contrast value and/or a calculated quantity from one of these values and/or their gradients of a pixel and/or pixel clusters in a camera image (6).

According to a further aspect, the determined trailer end is verified by one of the methods disclosed herein.

According to another aspect, the corresponding actual positions of trailer ends defined in the stored block grids are obtained from another method.

According to another aspect, the disclosed method(s) further comprise tracking (updating) the position of the trailer end in camera images (6) successive in time depending on the position of the trailer (5) with respect to an image sensor acquiring the camera images (6) such that the trailer end appears at a preferred position within the monitor image of a display means (1) of a camera-based system.

According to another aspect, a camera-based system of a vehicle is disclosed, wherein the vehicle has a towing unit (4) and a trailer (5) rearwardly extending from and being pivotable to the towing unit (4), the method comprising:
at least one image capturing means (2) located at the towing unit (4) and comprising an image sensor for acquiring camera images (6) of the trailer (5) which are successive in time; and
at least one processing means (3) configured for performing some of the disclosed methods.

In accordance with another aspect, a camera-based system is disclosed, comprising
at least one display means (1) for displaying of a camera image (6) captured by the at least one image capturing means (2) and tracking (updating) the position of the trailer end in the camera images (6) which are successive in time, depending on the position of the trailer (5) with respect to the image sensor acquiring the camera images (6) such that the trailer end appears at a preferred position within the monitor image of the display means (1).

In accordance with another disclosed aspect, the disclosed cCamera-based system is approved according to UN ECE R46.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

In the following, the invention is described purely by way of examples with reference to the attached figures with identical reference signs indicating identical or similar components.

FIG. 1 shows a schematic representation of a camera-based system according to a preferred embodiment of the present invention;

FIG. 2 shows a top view of a vehicle using the camera-based system of FIG. 1;

FIG. 3 shows a camera image captured by the camera system of FIG. 1;

FIG. 4 shows the camera image according to FIG. 3 for illustrating the determination of feature points;

FIG. 5 shows the camera image according to FIG. 4 with a block grid according to the preferred embodiment of the invention;

FIG. 6 shows a cell of the block grid of FIG. 3 with feature points according to the preferred embodiment of the invention; and

FIG. 7 shows a camera image according to FIG. 3 displayed on a monitor as a monitor image with tracked (updated) trailer end position.

### DETAILED DESCRIPTION OF THE PRESENTLY PREFERRED EMBODIMENTS

FIG. 1 shows a camera-based system according to a preferred embodiment of the invention having display means 1a, 1b, image capturing means 2a, 2b and processing means 3a, 3b.

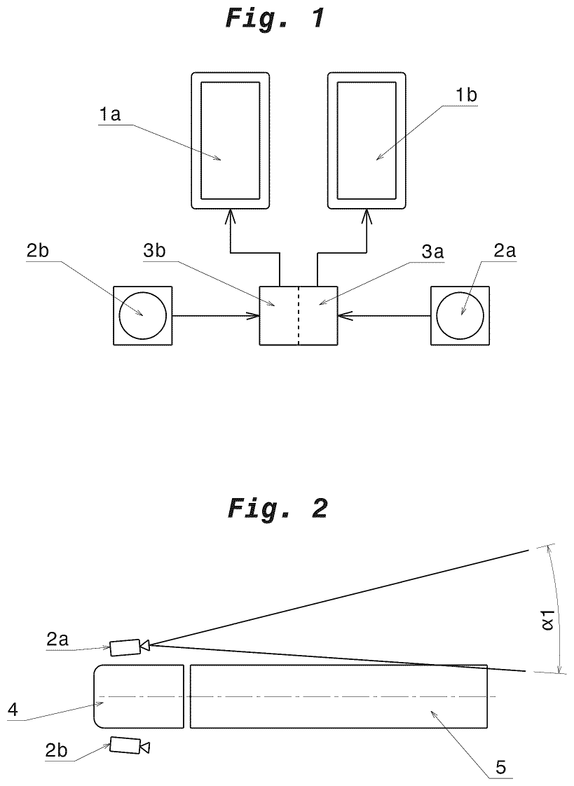

The image capturing means 2a, 2b are preferably arranged on opposite sides of a vehicle, and respectively connected to the display means 1a, 1b via the processing means 3a, 3b. The image capturing means 2a, 2b are arranged on opposite sides of the vehicle, as for example shown in FIG. 2. The processing means 3a, 3b according to the preferred embodiment comprise, for example, buckling angle determination means and image data processing means, not described in more detail, and are in particular able to carry out the method according to the invention for determining the position of the trailer end, and for tracking (updating) and correcting the trailer end position on the display means 1a, 1b, as described below.

For the sake of simplicity, only the display means 1a, the image capturing means 2a and the processing means 3a are described. However, the explanations apply analogously to the display means 1b, the image capturing means 2b and the processing means 3b on the opposite side of the vehicle. Further, according to the preferred embodiment, only a single processing unit can be provided which assumes the function of the processing means 3a and 3b.

As shown in FIG. 2, the vehicle comprises a towing vehicle 4 and a trailer 5 pivotably attached thereto, for example. The image capturing means 2a covers with its recording area a viewing area or a field of view which corresponds to a “main mirror (large) group II” according to ECE-R46. Other suitable defined fields of view can be covered by the image capturing means 2a in accordance with national regulations.

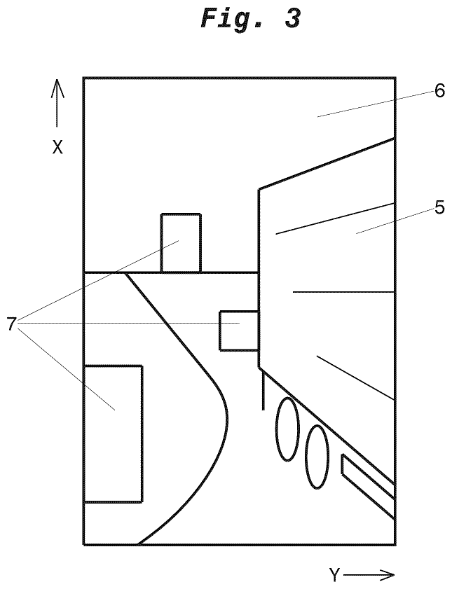

FIG. 2 shows the vehicle travelling straight ahead without a buckling angle between the towing vehicle 4 and the trailer 5. When cornering, the buckling angle between the towing vehicle 4 and the trailer 5 is generated, and the rear end of the trailer 5 is shifted (moved) in the field of view of the image capturing means 2a with increasing buckling angle. FIG. 3 shows a camera image 6 captured by the image capturing means 2a, wherein the end of the trailer 5 conceals the rearward traffic with increasing buckling angle. The image capturing means 2a can capture a series of images successive in time.

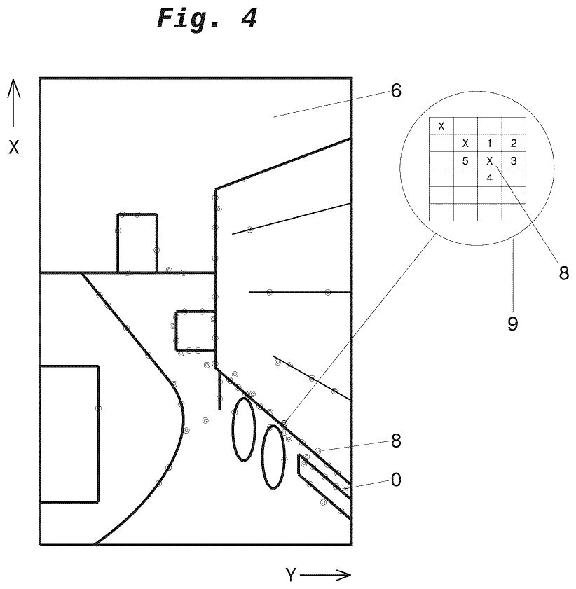

FIG. 3 shows a camera image 6 captured by the camera-based system of FIG. 1 as a monitor image of the trailer 5 displayed on a monitor and rearward traffic 7. FIG. 4 serves to illustrate the determination of feature points 8 in this camera image 6.

According to a preferred embodiment of the method according to the invention for verifying the trailer end or the trailer end edge in the camera image 6, a plurality of feature points 8 are determined in the two-dimensional camera image 6 with coordinate axes x and y, as shown in FIG. 4. The feature points 8 each correspond to a single pixel or several pixels in a pixel cluster. FIG. 4 illustrates a pixel field 9 in an enlarged view of a partial section of the camera image 6. According to the preferred embodiment, for example, a pixel that has the neighboring pixels 1 to 5 is determined as feature point if there is a predetermined contrast difference at least to a part of the neighboring pixels. Other image parameters for defining whether a pixel is a feature point, or not, can be alternatively or additionally used.

According to the preferred embodiment of the method according to the invention, the feature points 8 determined in FIG. 4 can be weighted for emphasizing or better determining a contrast difference between neighboring pixels or pixels in spatial proximity. A weighing parameter can for example be speed at which feature points change (move) relative to the tractor, i.e. regarding their position on the image sensor: none or only minor changes can be weighted higher, as it can be assumed that they are points that move with the vehicle and are therefore on the trailer, for example. For the further processing according to the method of the invention, only feature points having a predetermined weighting or higher, for example, are used so that not all feature points must be used which saves computing capacity.

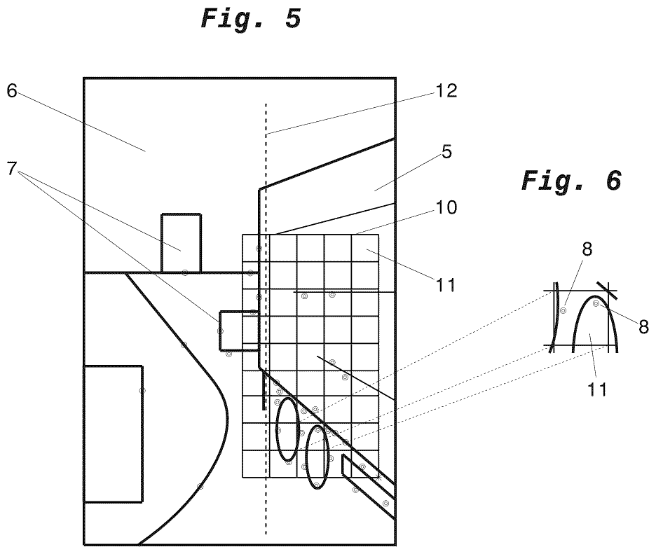

According to the preferred embodiment of the method according to the invention, a block grid 10 is generated on at least a part of the camera image 6, as shown in FIG. 5. The first block grid 10 may be generated by using a starting point 0 shown in FIG. 4, for example. The block grid 10 comprises a plurality of columns and rows which define a plurality of cells 11. In the block grid 10 in FIG. 5, the number of columns is different from the number of rows. In principle, a grid layout other than rectangular cells could also be used. FIG. 5 shows also a trailer end to be verified indicated as a vertical line 12, which trailer end is for example obtained by an external method for determining a trailer end.

According to the preferred embodiment of the method according to the invention, a distribution of the plurality of feature points 8 determined in the above-mentioned manner is determined over the plurality of cells 11. The cells 11 shown in FIG. 6, for example, comprise two feature points 8. The distribution of feature points over the cells of the generated block grid 10 is then compared with distributions of feature points of a plurality of corresponding stored block grids (not shown). The stored block grids each define different distributions of feature points together with a position of the actual trailer end and a buckling angle. According to the preferred embodiment of the method according to the invention, based on the buckling angle and a correlation of the distribution of the feature points in the generated block grid and in the stored block grids, a corresponding stored block grid is selected which defines the actual trailer end. By comparing this actual trailer end with the (input) previously determined trailer end, this can be verified and, if necessary, discarded or corrected.

According to the preferred embodiment of the method according to the invention, the distribution of the feature points and the corresponding (actual) trailer ends stored in the stored block grids can be stored in advance or generated and stored in real time at fixed defined or dynamically time intervals during performing the method.

By using stored block grids which in addition to the distribution of the feature points over the cells store information about the trailer end position, according to the preferred embodiment of the method according to the invention for determining the position of the trailer end, the trailer end can be determined in the above way without the presence of a trailer end position to be verified by comparing a generated block grid with the stored block grids and can be used for center tracking within a camera image, as mentioned above.

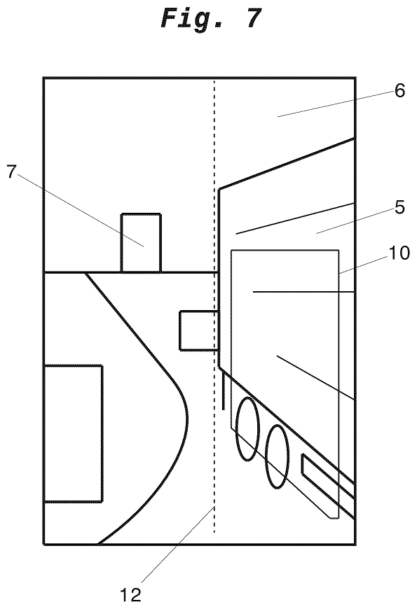

FIG. 7 shows a tracked (updated) position of the trailer end in a camera image 6 at a preferred position in a displayed monitor image. The preferred position is for example the center of the monitor image or shifted to left or right by 0% to 25% from the center, for example. This preferred position can also be offset by 0% to 25% from the left or right edge of the monitor image.

It is explicitly emphasized that all features disclosed in the description and/or the claims are understood to be separate or independent of each other for the purpose of the original disclosure as well as for the purpose of limiting the claimed invention independently of the combination of the features in the embodiments and/or claims. It is explicitly stated that any range specifications or specifications of groups of units include any intermediate value or subgroup of units for the purpose of the original disclosure as well as for limiting the claimed invention, in particular also the limit of a range indication.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. A method for verifying a method for tracking an end of a trailer comprising the steps of:
receiving at least an information about the position of a trailer end of a trailer extending rearward from a towing unit of a vehicle and being pivotable to the towing unit, from the method for tracking a trailer end;
capturing a camera image of at least a side area of the trailer by an image sensor of at least one image capturing means;
determining a plurality of feature points in the camera image based on at least one image parameter, wherein a feature point corresponds to at least one pixel in the camera image;
generating a block grid on at least a part of the captured camera image, wherein the block grid defines a plurality of cells, and determining a distribution of the plurality of feature points over the plurality of cells of the block grid as part of the generated block grid;
comparing the distribution of the feature points in the generated block grid with distributions of feature points of a plurality of corresponding stored block grids, wherein the stored block grids each define different distributions of feature points together with an actual trailer end;
selecting one of the stored block grids based on a correlation between the distribution of feature points in the generated block grid and the distributions of feature points in the stored block grids;
verifying the received information about the position of the trailer end by comparing the actual position of the trailer end defined by the selected block grid with the received information about the position of the trailer end.

2. The method according to claim 1, further comprising a correcting of the received information about the position of the trailer end based on the verification.

3. The method according to claim 1, wherein the distributions of the feature points and the corresponding trailer ends in the stored block grids are stored in advance or generated and stored in real time at fixed defined or dynamically adjustable time intervals.

4. The method according to claim 1, wherein the distribution of feature points in one of the stored block grids differs from the distribution of feature points in another of the stored block grids according to the relative positional relationship between trailer and towing unit.

5. The method according to claim 1, wherein the at least one image parameter is at least a brightness value, color value, grey tone, contrast value and/or a calculated quantity from one these values and/or their gradients of a pixel and/or pixel clusters in a camera image.

6. The method according to claim 1, wherein the method for tracking (updating) a position of a trailer end is a radar-based method, an ultrasonic method, a Lidar-based method, a CAN-based method and/or an optical method.

7. The method according to claim 1, wherein a feature point corresponds to a pixel or a cluster of few directly adjacent pixels or pixels in close proximity to each other.

8. The method according to claim 1, wherein the corresponding actual trailer ends defined in the stored block grids are obtained from another method.

9. The method according to claim 1, comprising tracking (updating) the position of the trailer end such that the trailer end appears at a preferred position in the monitor image of at least one display means of a camera-based system.

10. A camera-based system of a vehicle having a towing unit and a trailer rearwardly extending from and being pivotable to the towing unit, comprising:
at least one image capturing means provided at the towing unit and having at least one image sensor for capturing camera images of the trailer which are successive in time; and
at least one processing means configured for performing the method according to claim 1.

11. The camera-based system according to claim 10, further comprising:
at least one display means for displaying a camera image captured by the at least one image capturing means and tracking the position of the trailer end in the camera images which are successive in time, depending on the position of the trailer with respect to an image sensor acquiring the camera images such that the trailer end appears at a preferred position within the monitor image of the display means.

12. The camera-based system according to claim 10, which is approved according to UN ECE R46.

13. A method for determining a trailer end of a trailer extending rearward from a towing unit of a vehicle and being pivotable to the towing unit, comprising the steps of:
capturing a camera image of the trailer by an image sensor of at least one image capturing means;
determining a plurality of feature points in the camera image based on at least one image parameter, wherein a feature point corresponds to at least one pixel in the camera image;
creating a block grid on at least a part of the captured camera image, wherein a block grid defines a plurality of cells, and determining a distribution of the plurality of the feature points over the plurality of cells of the block grid as part of the created block grid;
comparing the distribution of the feature points in the created block grid with distributions of feature points of a plurality of corresponding stored block grids, wherein the stored block grids each define different distributions of feature points together with actual positions of trailer ends;
selecting one of the stored block grids based on a correlation between the feature points in the created block grid and the feature points in the stored block grids;
determining the position of the trailer end which is defined in the selected block grid as the end of the trailer.

14. The method according to claim 13, wherein the distribution of the feature points and the corresponding trailer ends in the stored block grids are stored in advance or created and stored in real time at fixed defined or dynamically adjustable time intervals.

15. The method according to claim 13, wherein the at least one image parameter is at least one of a brightness value, color value, grey tone, contrast value and/or a calculated quantity from one of these values and/or their gradients of a pixel and/or pixel clusters in a camera image.

16. The method according to claim 13, wherein the determined trailer end is verified by:
receiving at least an information about the position of a trailer end of a trailer extending rearward from a towing unit of a vehicle and being pivotable to the towing unit, from the method for tracking a trailer end;
capturing a camera image of at least a side area of the trailer by an image sensor of at least one image capturing means;
determining a plurality of feature points in the camera image based on at least one image parameter, wherein a feature point corresponds to at least one pixel in the camera image;
generating a block grid on at least a part of the captured camera image, wherein the block grid defines a plurality of cells, and determining a distribution of the plurality of feature points over the plurality of cells of the block grid as part of the generated block grid;
comparing the distribution of the feature points in the generated block grid with distributions of feature points of a plurality of corresponding stored block grids, wherein the stored block grids each define different distributions of feature points together with an actual trailer end;
selecting one of the stored block grids based on a correlation between the distribution of feature points in the generated block grid and the distributions of feature points in the stored block grids; and
verifying the received information about the position of the trailer end by comparing the actual position of the trailer end defined by the selected block grid with the received information about the position of the trailer end.

17. The method according to claim 13, wherein the corresponding actual positions of trailer ends defined in the stored block grids are obtained from another method.

18. The method according to claim 13, further comprising tracking (updating) the position of the trailer end in camera images successive in time depending on the position of the trailer with respect to an image sensor acquiring the camera images such that the trailer end appears at a preferred position within the monitor image of a display means of a camera-based system.

19. A camera-based system of a vehicle having a towing unit and a trailer rearwardly extending from and being pivotable to the towing unit, comprising:
at least one image capturing means located at the towing unit and comprising an image sensor for acquiring camera images of the trailer which are successive in time; and
at least one processing means configured for performing the method according to claim 13.

20. A camera-based system, comprising:
at least one display means for displaying of a camera image captured by the at least one image capturing means and tracking (updating) the position of the trailer end in the camera images which are successive in time, depending on the position of the trailer with respect to the image sensor acquiring the camera images such that the trailer end appears at a preferred position within the monitor image of the display means.

21. The camera-based system according to claim 19, which is approved according to UN ECE R46.

22. The camera-based system according to claim 20, which is approved according to UN ECE R46.
